(19) United States
(12) Patent Application Publication
(10) Pub. No.: US 2009/0121112 A1
(43) Pub. Date: May 14, 2009

(54) SYSTEM FOR FABRICATING BOX BEAMS

(76) Inventors: Frank M. Clark, Pittsburgh, PA (US); Joel Hough, Pittsburgh, PA (US); Fred Gurney, Austin, TX (US); Rick Uhal, McKeesport, PA (US)

Correspondence Address: REED SMITH LLP, P.O. BOX 488, PITTSBURGH, PA, 15230-0488, US

(21) Appl. No.: 12/206,610

(22) Filed: Sep. 8, 2008

Related U.S. Application Data
(60) Provisional application No. 60/970,930, filed on Sep. 7, 2007.

(51) Int. Cl. F16M 11/24

(52) U.S. Cl. 248/371

(57) ABSTRACT

In the context of precision assembly tables for box beams and components and systems associated or connected with such assembly tables, innovations including but not limited to: fitup arms of a generally “scissors” configuration, a control system for such fitup arms, automatic and manual clamps that can be employed with such fitup arms or other fitup arms, an overall rapid configuration system and process for fabricating trapezoidal box shapes.

### CROSS-REFERENCE TO RELATED U.S. APPLICATION

This application claims priority under 35 U.S.C. 119 (e) from U.S. Provisional Patent Application Ser. No. 60/970,930, filed on Sep. 7, 2007.

### FIELD OF THE INVENTION

The present invention relates generally to precision assembly tables for box beams and to components and systems associated or connected with such assembly tables.

### BACKGROUND OF THE INVENTION

Precision assembly tables for magnetic levitation system guideways have hitherto been developed with favorable results. U.S. Pat. Nos. 6,453,544 and 6,202,275, both assigned to Maglev, Inc., provide examples. (These patents may also be relied upon for general background information by way of better understanding and appreciating embodiments of the present invention as broadly contemplated and disclosed herein.)

It is also recognized that properly configured precision assembly tables can find use in a host of applications, settings and industries outside of magnetic levitation system guideways. For instance, steel tub girders for use in highway and rail bridges, viaducts and overpasses and the like often have a generally trapezoidal cross-section highly analogous to that found in a typical magnetic levitation system guideway. For background information, the following publication can be consulted: “Practical Steel Tub Girder Design”, National Steel Bridge Alliance, April 2005, authors D. Coletti et al.

Accordingly, a growing and compelling need has been recognized in connection with providing precision assembly arrangements, and components and systems associated therewith, which easily lend themselves to a host of applications, settings and industries in general, including but of course not limited to the manufacture of magnetic levitation system guideways and most preferably inclusive of the manufacture of steel tub girders.

### SUMMARY OF THE INVENTION

Broadly contemplated herein, in accordance with at least one presently preferred embodiment of the present invention, are: fitup arms of a generally “scissors” configuration, a control system for such fitup arms, automatic and manual clamps that can be employed with such fitup arms or other fitup arms, an overall rapid configuration system and process for fabricating trapezoidal box shapes.

In summary, there is broadly contemplated herein, in accordance with at least one presently preferred embodiment of the present invention, an apparatus for supporting a contoured structure comprising: a base portion; an upper portion which supports a portion of a contoured structure; a connector interconnecting the base portion and the upper portion; an adjustment arrangement comprising: a first adjuster which adjusts a position of the upper portion with respect to the base portion in accordance with a first degree of freedom; and a second adjuster which adjusts a position of the upper portion with respect to the base portion in accordance with a second degree of freedom; the first adjuster acting to displace the upper portion with respect to the base portion directly; the second adjuster acting to displace the upper portion with respect to the base portion solely via a physical interposition between the upper portion and the base portion.

The novel features which are considered characteristic of the present invention are set forth herebelow. The invention itself, however, both as to its construction and its method of operation, together with additional objects and advantages thereof, will be best understood from the following description of the specific embodiments when read and understood in connection with the accompanying drawings.

### BRIEF DESCRIPTION OF THE DRAWINGS

FIG. 1 is a perspective view of a precision assembly table.

FIG. 2 illustrates several scissors-configured fitup arms in perspective view.

FIG. 3 illustrates, in perspective view, a scissors-configured fitup arm in isolation.

FIGS. 4a-4f illustrate, in elevational view, various positions assumed by scissors-configured fitup arms.

FIG. 5 illustrates a variant fitup arm arrangement.

FIG. 6 illustrates an operator's screen console in accordance with a fitup arm arrangement.

FIG. 7 illustrates, in perspective view, a manually operable clamp that may be employed with a fitup arm.

FIG. 8 shows, in partially exploded perspective view, an alternative automatic clamp that may be employed with a fitup arm.

FIG. 9 schematically illustrates a process of designing and configuring a box beam structure.

### DETAILED DESCRIPTION OF THE PREFERRED EMBODIMENTS

In general overview, to the extent that any specific dimensions may appear in one or more drawings, it should be understood that these are provided merely by way of illustrative and non-restrictive example, and are not to be construed as limiting upon the embodiments of the present invention.

It will be appreciated from the discussion herethroughout that one visible difference between steel tub girders and magnetic levitation system guideways resides in that steel tub girders tend to have an open cross section, wherein no material typically bridges across a major or maximal width of the trapezoidal cross section, whereas magnetic levitation system guideways tend to have a closed or partly closed cross section, wherein some amount of material (e.g., crosspieces, or an entire cover piece) typically bridges across the same major or maximal width of the trapezoidal cross section. However, it will be appreciated that this is a minor distinction in the context of precision assembly tables and that minor adjustments, as needed, can easily be made to customize a precision assembly table for one context or the other.

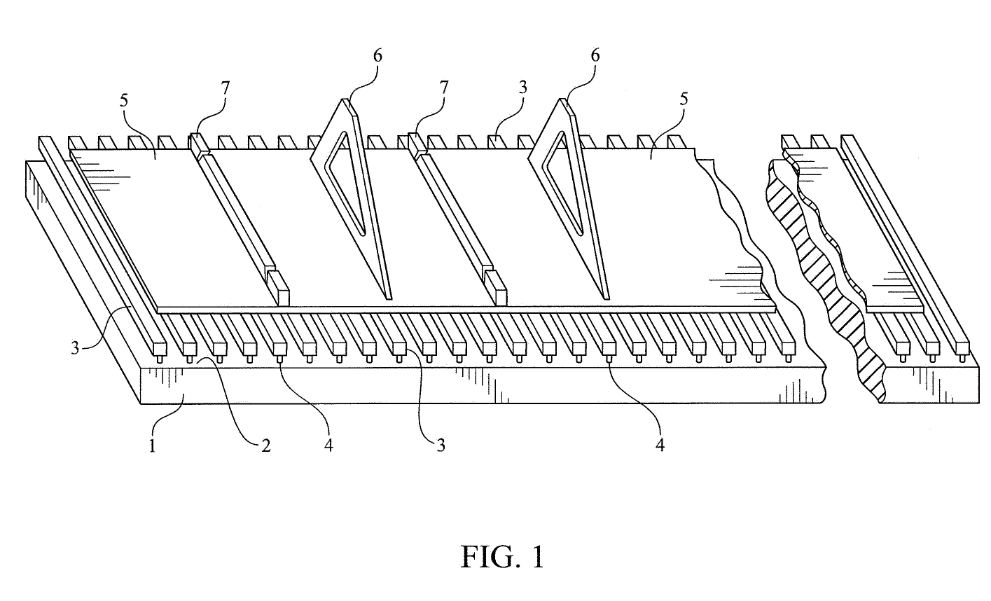

By way of providing general background and also of appreciating a context in which embodiments of the present invention may readily be employed, FIG. 1 provides a perspective view of a conventional precision assembly table and basic components thereof. Additional details thereof may be appreciated from the prior Maglev patents cited hereinabove.

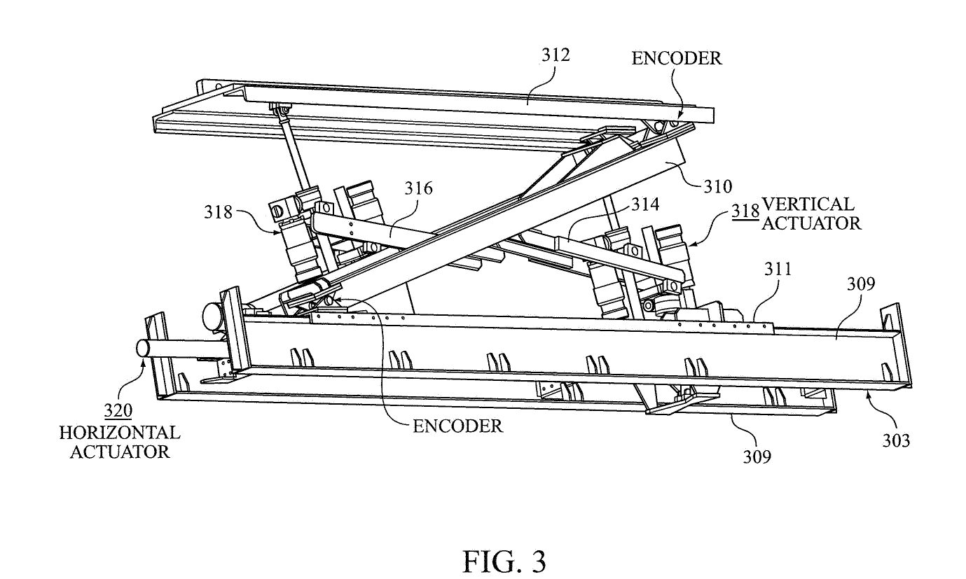

As shown, a precision assembly table may include a frame 1 connected to a surface 2 over which rigid bars 3 are positioned by adjustable support members 4 which are connected to the rigid bars 3 and the frame 1 and necessarily pass through the surface 2. As depicted, the frame 1 supports the surface 2 above the ground, and the frame further supports the adjustable support members 4 which protrude through the surface 2 to support the rigid bars 3 above the surface 2, above the frame 1, and above the ground. The frame 1 is very rigid and typically is connected to the factory floor or ground to prevent movement of the frame 1, thereby avoiding interference with the assembly. The frame 1 can be of a variety of configurations, provided that it provides a rigid and stable apparatus upon which the surface 2 and adjustable support members 4 can be connected. The surface 2 is utilized to shield the frame 1 and the apparatus associated with adjustable support members (see FIG. 3 of the prior Maglev patents, supra), from materials and damage resulting from the assembly operations taking place on top of the rigid bars 3.

The frame 1 may be used in connection with the adjustable support members 3 and rigid bars 2 without the presence of the surface 2, whereby the apparatus would perform the method of assembly in the same manner. The structures to be assembled, such as guideways, are not required to, and preferably do not, rest on the surface 2 but rather on the tops of the rigid bars 3; this is readily depicted in FIG. 1, which shows a magnetic levitation guideway guide plate 5 positioned on the tops of the rigid bars 3.

The rigid bars 3 are typically parallel to each other and set apart from each other by a fixed distance (e.g., one foot apart). Other applications and particularly complex or curved contours may require more rigid bars 3 closer together. In some circumstances, the rigid bars 3 would not necessarily need to be parallel to each other. Some applications would not require as many rigid bars 3 such that the rigid bars 3 could be placed more than one foot apart. The skilled artisan is credited with the ability to ascertain any such requirements that such applications may require with respect to such spacing.

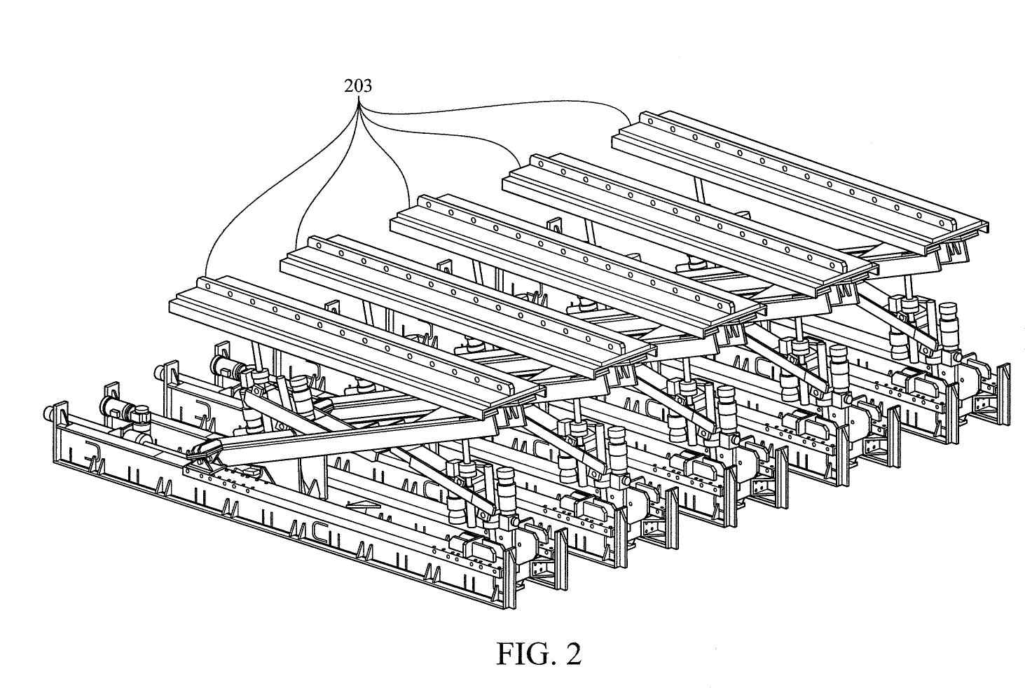

While the general arrangement shown in FIG. 1 presents rigid bars for supporting a workpiece, a particularly advantageous arrangement in accordance with an embodiment of the present invention presents a “scissors” configuration that has been found to accommodate curved or other irregularly designed structures with superb precision and flexibility. As such, FIG. 2 illustrates in perspective view five such “scissors”-configured fitup arms 203, the components of which will be better appreciated from the discussion herebelow. While dimensions and layouts of fitup arms may be suitably configured and customized for the application at hand, it should be appreciated that a system in accordance with at least one embodiment of the present invention may well accommodate a multitude of fitup arms configured for supporting a significantly long workpiece. For example, a system comprising 41 fitup arms may be provided to accommodate a 60-meter beam, wherein each of the 41 arms is driven independently to move to a position based on a computer design. Each arm thus may be finitely positioned from the design software being used.

For the balance of the instant disclosure, with regard to FIGS. 2-9, reference numerals indicating similar components are advanced by multiples of 100.

FIG. 3 illustrates, in perspective view, a scissors-configured fitup arm 303 in isolation. Particularly depicted in FIG. 3 is the positioning of actuators and encoders on a fitup arm in accordance with an embodiment of the present invention

As shown, fitup arm 303 may preferably include a pair of parallel base pieces 309 that support a lower piece 311 that is preferably slidably mounted on base pieces 309. Hingedly attached to lower piece 311 is a main connecting piece 310 which itself is hingedly attached to an upper piece 312 (the latter essentially being analogous in function to the rigid bars 3 shown in FIG. 1). Also preferably included are vertical actuators 318 and associated crosspieces 314/316.

Actuators 318 are preferably provided in two sets, as shown. In one set, towards the left side of the drawing, a vertical actuator preferably controls motion of crosspiece 316 with respect to connecting piece 310, while another preferably controls motion of upper piece 312 with respect to lower piece 311 (via the upwardly extending rod that is visible in the drawing). In the other set, towards the right side of the drawing, a vertical actuator preferably controls motion of crosspiece 314 with respect to connecting piece 310, while another preferably controls motion of upper piece 312 with respect to lower piece 311 (via the upwardly extending rod that is visible in the drawing). Each crosspiece 314/316 is preferably anchored to a corresponding one of the actuators 318 (particularly, those actuators that control upper piece 312) so that actuation of a crosspiece by another actuator will transmit a fine-tuning motion to connecting piece 310 to help position upper piece 312 more precisely (and provide a “canting” adjustment distinct from that provided by horizontal actuator 320).

For its part, horizontal actuator 320 may preferably be configured to move the ensemble of pieces 311/310/312/314/316/318 laterally, i.e., in a direction parallel to the lie of base pieces 309.

The actuators 318/320 may be embodied in any suitable manner, but particularly favorable results have been noted in connection with worm gears or spindle drives. There may also preferably be provided encoders as shown, which among other things could serve to transmit positional feedback information to a control system.

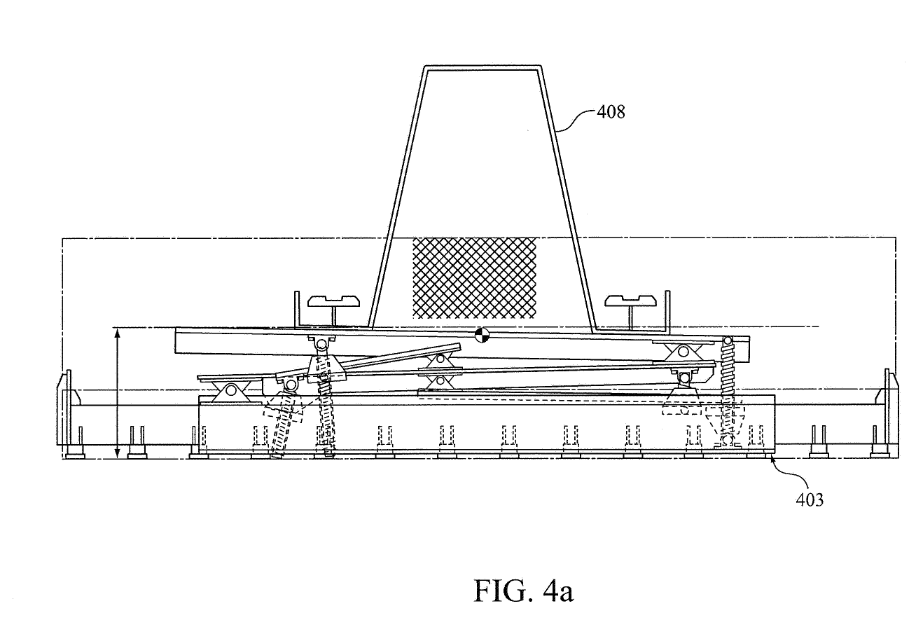

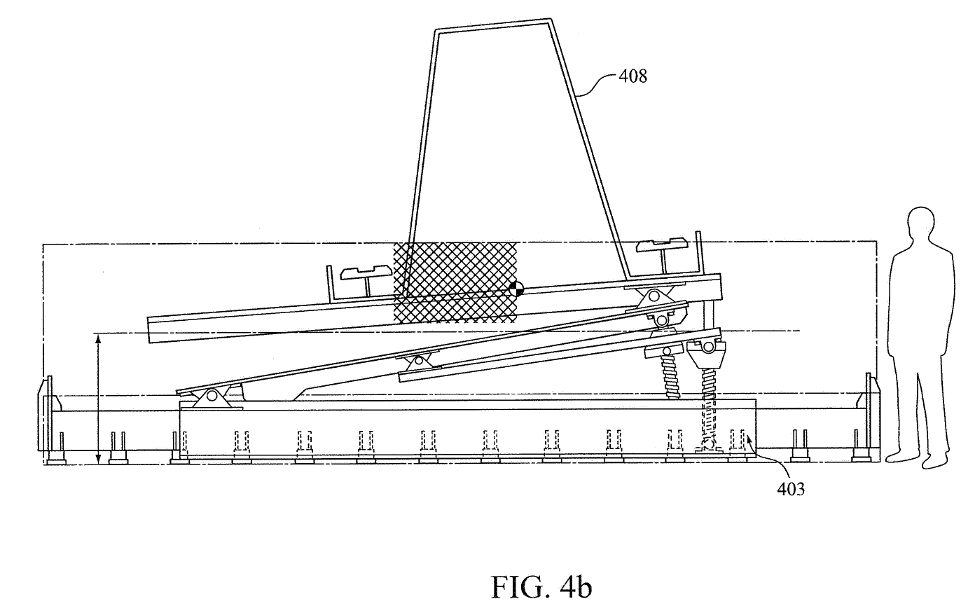

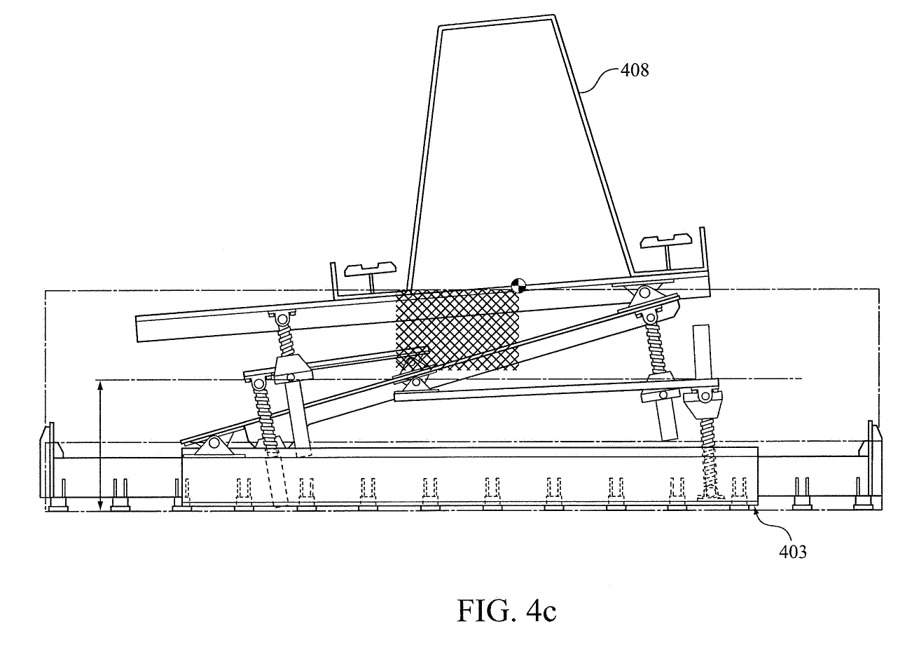

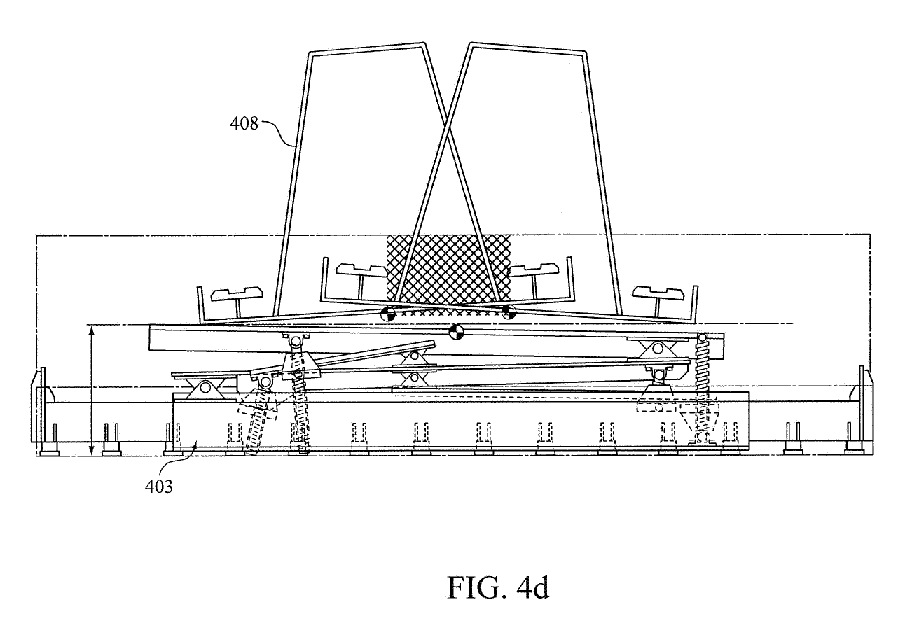

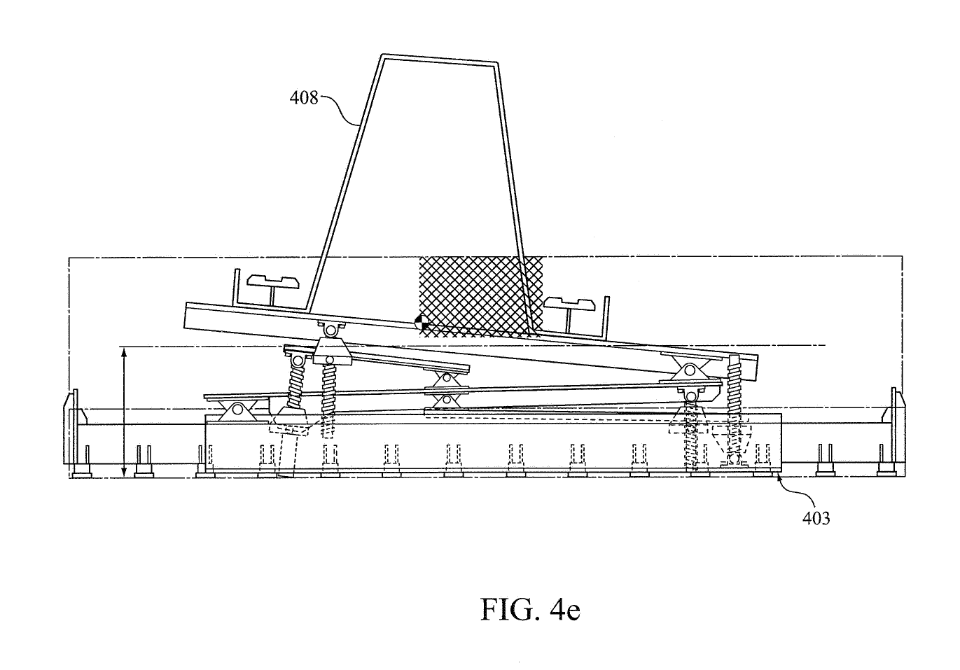

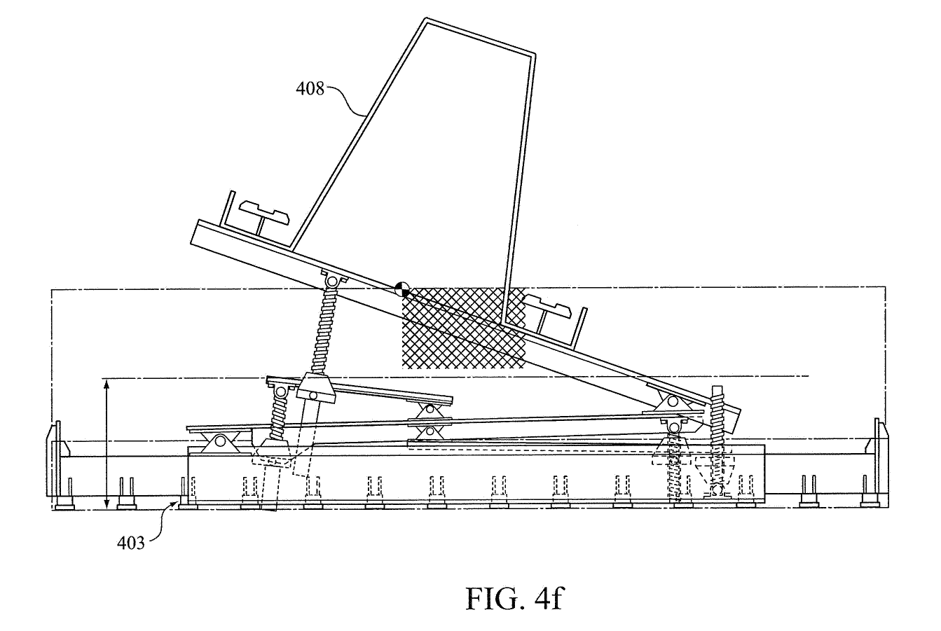

FIGS. 4a-f build on the arrangements shown in FIGS. 2 and 3 and illustrate, in various views, different positions that may be assumed by a fitup table (and, by extension, of fitup arms thereof), wherein several degrees of freedom of movement are afforded; a beam in trapezoidal cross-section is shown in each view.

It should first be appreciated, as discussed hereinabove with relation to FIG. 3, that each fitup arm 403 may preferably be individually displaceable so as to move strictly laterally (i.e., in a horizontal orientation with respect to FIGS. 4a-f) and/or vertically and/or in a “canting” motion side-to-side (i.e., a fine-tuned motion governed by action of crosspieces such as those indicated at 314/316 in FIG. 3), all by way of precisely adopting a cooperating shape which accommodates a curved or other irregularly shaped beam to be supported. The discussion herethroughout will help lend an appreciation that the ensemble of fitup arms in a system according to embodiments of the present invention will be readily configured to quickly and accurately “snap” from a first configuration (such as an initial, rest configuration where all fitup arms are at a lowermost position and essentially horizontal) to a “target” configuration (e.g., a configuration for accommodating a particular curved beam).

Generally, FIGS. 4a-4f convey just a smattering of the great variety of motions and positions that can be adopted and undertaken by a fitup table arrangement in accordance with at least one embodiment of the present invention. As shown, a beam with a trapezoidal cross-section (408) can be mounted atop a fitup arm 403; fitup arm 403 itself may preferably be configured in similar manner to the fitup arm 303 set forth in FIG. 3. FIGS. 4a-4f show a progression of motions that can be imparted to workpiece 408, via a precision positioning arrangement such as that shown in FIG. 3, whereby from a rest or lowered horizontal position (FIG. 4a), the workpiece can be tilted to the left (FIG. 4b), thence this slope can be maintained while the entire workpiece displaces upwardly (FIG. 4c). At another juncture, the workpiece 408 can be selectively canted or tilted left or right (FIG. 4d), whereupon after being tilted rightwardly (FIG. 4e), an even steeper slope can be imparted to the workpiece 408 (FIG. 4f) without necessarily imparting a net vertical displacement to any part of the right side of the fitup arm 403. It should thus be appreciated that a fitup arm arrangement in accordance with at least one embodiment of the present invention provides considerable freedom of movement and adjustment without an excess of distinct, or distinctly moving, parts.

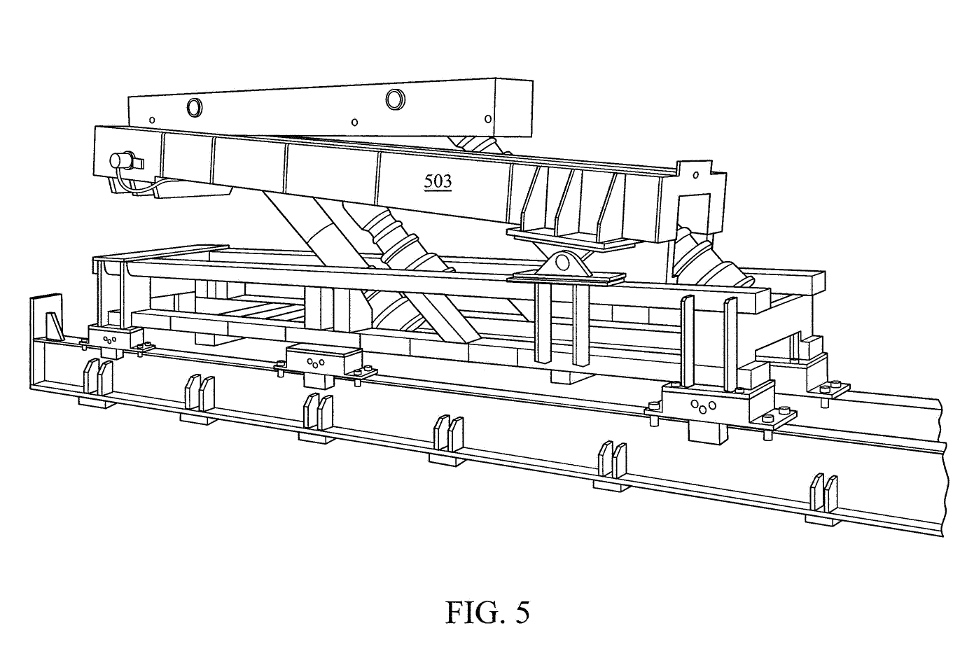

FIG. 5 illustrates an alternative fitup arm arrangement 503 in the form of a “one-arm” arrangement. Here, larger hydraulic cylinders may actuate a larger central arm (itself hingedly displaceable with respect to a lower base) while a smaller hydraulic cylinder may actuate a smaller upper arm that, in turn, is hingedly displaceable with respect to the central arm. Again, this provides a simplicity of configuration that nonetheless affords a tremendous range of precision movements and adjustments.

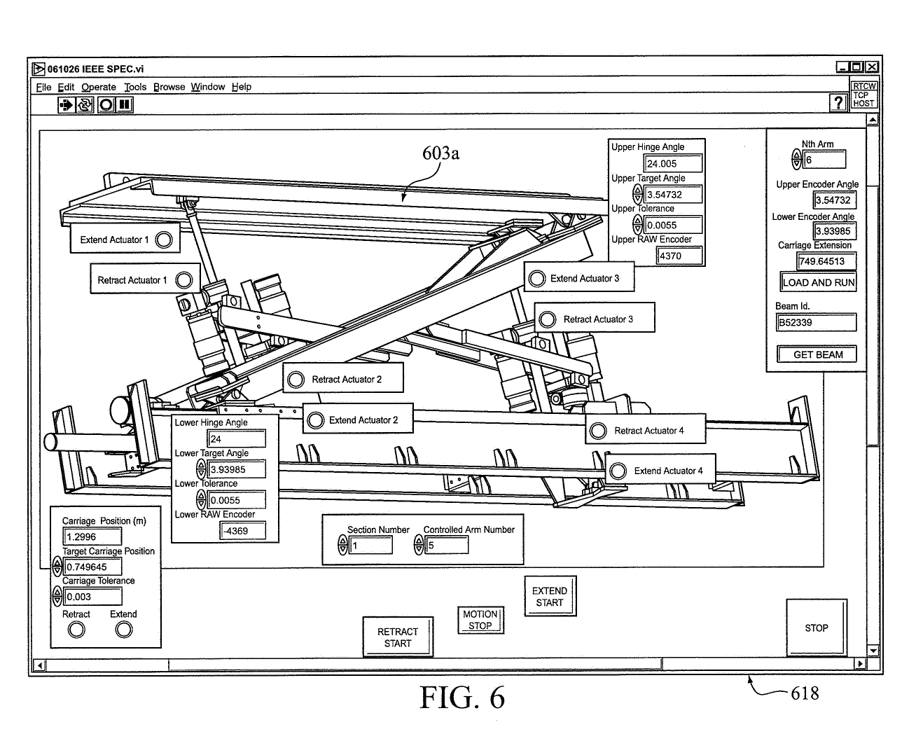

Shown in FIG. 6 is a screenshot from an operator console conveying the versatility of a control system in accordance with an embodiment of the present invention. Parameters which control the positioning and movement of a fitup arm may be pre-programmed in a defined sequence or could be manually entered as needed by an operator. In more particularity, FIG. 6 conveys a user interface 618 (e.g., at a computer) that may be employed in accordance with at least one embodiment of the present invention. As shown, an image 603a of a given fitup arm may be displayed at the interface 603 along with fields that permit changes to be made in parameter values relating to the positioning of the fitup arm in question. Such changes can be brought about in essentially any suitable manner, and FIG. 6 conveys but an illustrative and non-restrictive example. As such, for instance, fields can be provided to set: target angles for the two large hinge connections (upper piece with respect to connecting piece, connecting piece with respect to lower piece or “carriage”); horizontal position of the lower piece (“carriage”); and indicator lights which convey whether any the four vertical actuators (“Actuator 1”, “Actuator 2”, etc.) or horizontal actuator (for the “carriage”) are being retracted and extended. Other fields can control which arm is to be displayed (e.g., the number of an arm relative to a subset [“section”], such as a subset of five arms) and can convey which beam in particular is being supported by the arm.

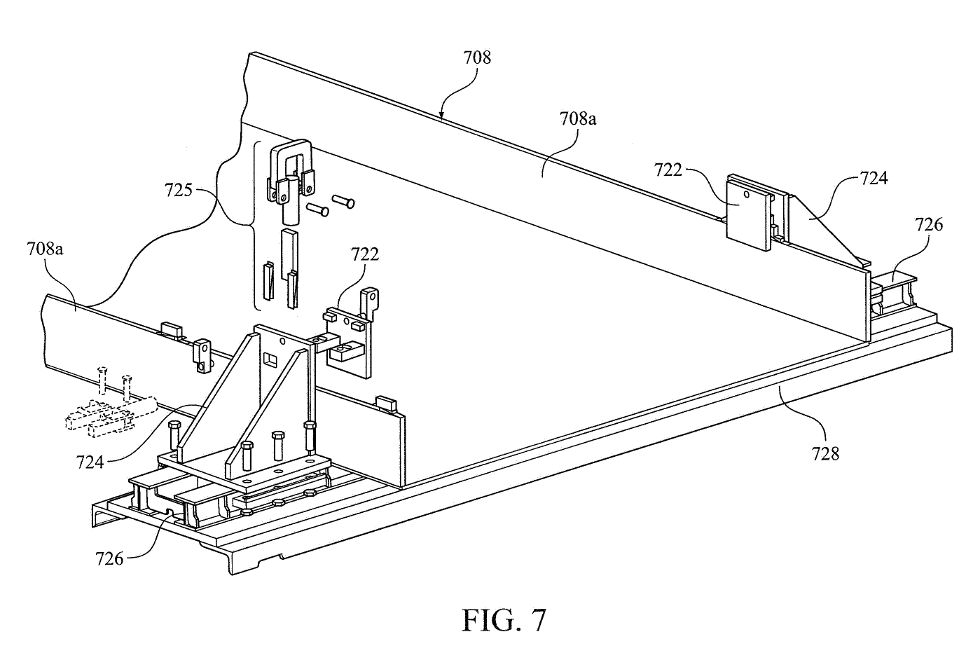

FIG. 7 illustrates a manually operable clamp that may be employed with a fitup arm in accordance with an embodiment of the present invention. Shown are two cooperating sides of a clamp structure, flanking a lowermost beam section 708. Components of the clamp are shown in exploded view.

As shown, a base of the clamp 728 may preferably serve to undergird the beam section 708. On each opposing side of the beam section 708, a main support 724 may be slidably mounted on a track 726, while main support 724 can selectively be fixed in position with respect to track 726 via any suitable arrangement such as bolts. On the other hand, a clamping portion 722 on each side may preferably act to clamp a corresponding upwardly extending flange 708a of beam section 708 with respect to main support 724. Thus, preferably, each clamping portion 722 may preferably be slidably displaceable with respect to main support 724 so as to selectively displace towards or away from main support 724, while a suitable locking mechanism 725 (shown in exploded view) can preferably serve to lock clamping portion 722 in place with respect to support 724.

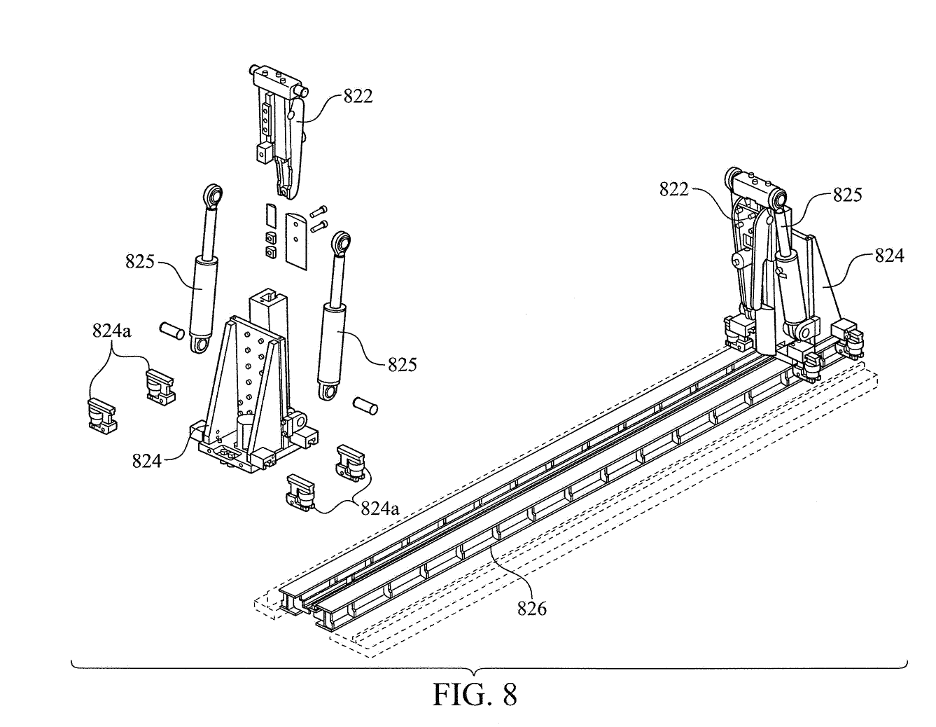

FIG. 8 shows, in partially exploded perspective view, an alternative automatic clamp that may be employed with a fitup arm in accordance with an embodiment of the present invention. Such an automatic clamp may preferably be computer-controlled via the same system as that which controls the fitup arms themselves. Here, hydraulic cylinders are employed to facilitate the gripping of vertical edges of a beam section. Accordingly, as shown, a lower track 826 may preferably have slidably mounted thereon opposing main supports 824 (themselves analogous to the main supports 724 of FIG. 7). The main supports 824 may interconnect with track 826 in essentially any suitable manner, e.g., via wheels such as indicated at 824a. As with the manual arrangement in FIG. 7, here there may be clamping portions 822 that respectively cooperate with corresponding main supports 824 to clamp a flange of a workpiece (not illustrated) therebetween. However, here there may preferably be provided hydraulic cylinders 825 (controlled preferably by the same control system that controls fitup arms) that selectively move the clamping portions 822 away from or towards supports 824 in order to selectively unclamp or clamp a flange of a workpiece.

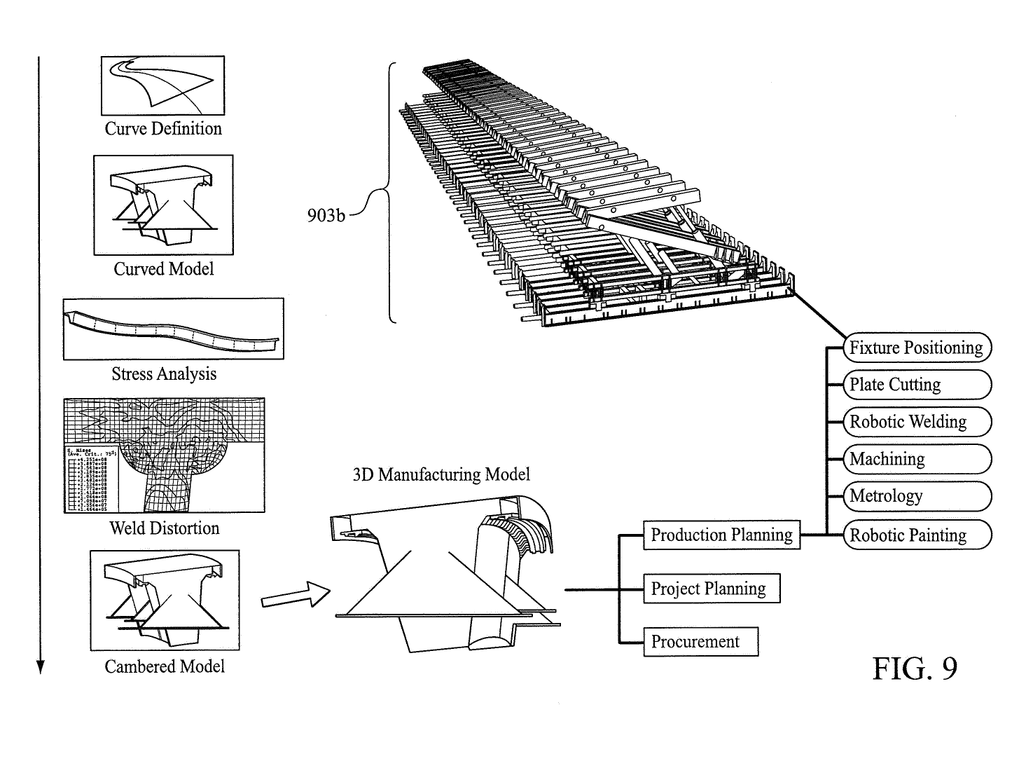

FIG. 9 illustrates schematically a complete methodology for fabricating compound curvature beams (e.g., magnetic levitation guideways or steel tub girders), from a curve definition at a computer, to a curved beam model, whereupon stress analysis and weld distortion models can redefine the curved model into a cambered model that takes into account the ultimate effects of physical stress and weld distortion on the actual bema to be manufactured. A 3D manufacturing model at the computer can then preferably be fed, as suitable, into planning processes, including production processes that can include, inter alia, robotic painting, metrology, machining, robotic welding, plate cutting, all with respect to fixture positioning at a fitup table ensemble 903b.

By way of brief recapitulation, preferably, a methodology in accordance with at least one embodiment of the present invention includes a series of special purpose automated, re-configurable fitup tables, coupled through a common database with design and CAD programs. Essentially, the methodology provides a system to translate a design curve in space to the shop floor.

Preferably, software programs are melded with CAD design to cut plates to curvature, position the fitup tables and robotically weld the fabrications, and precise laser measurement can provides feedback of as to actual built dimensions vs. design dimensions. Complex geometry shapes can easily be designed and built in a single shop. Among the very wide variety of beams that can be produced are: magnetic levitation guideway beams, bridge girders, ship components, or just about any box beams designed to be straight or to include curvatures.

By way of even further elaboration on various features which may be broadly embraced in accordance with an overall system and methodology afforded in accordance with at least one presently preferred embodiment of the present invention, it is to be appreciated that there is broadly contemplated a precision rapid configuration system/process for fabricating trapezoidal box shapes to accommodate vertical and horizontal curvatures and transitions. More particularly, there is broadly contemplated herein a methodology (or system or process) for reducing the complexity of fabricating trapezoidal box shapes to accommodate vertical curvature, horizontal curvature, super-elevation transitions, and/or skews for reduction of cost of steel plate fabrications. Reference, of course, may continue to be made to the accompanying drawings and

Without further analysis, the foregoing will so fully reveal the gist of the present invention and its embodiments that others can, by applying current knowledge, readily adapt it for various applications without omitting features that, from the standpoint of prior art, fairly constitute characteristics of the generic or specific aspects of the present invention and its embodiments.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, it may be assumed that all components and/or processes described heretofore may, if appropriate, be considered to be interchangeable with similar components and/or processes disclosed elsewhere in the specification, unless an express indication is made to the contrary.

If not otherwise stated herein, any and all patents, patent publications, articles and other printed publications discussed or mentioned herein are hereby incorporated by reference as if set forth in their entirety herein.

It should be appreciated that the apparatus and method of the present invention may be configured and conducted as appropriate for any context at hand. The embodiments described above are to be considered in all respects only as illustrative and not restrictive. All changes which come within the meaning and range of equivalency of the claims are to be embraced within their scope.

What is claimed is:

1. An apparatus for supporting a contoured structure comprising:
a base portion;
an upper portion which supports a portion of a contoured structure;
a connector interconnecting said base portion and said upper portion;
an adjustment arrangement comprising:
a first adjuster which adjusts a position of said upper portion with respect to said base portion in accordance with a first degree of freedom; and
a second adjuster which adjusts a position of said upper portion with respect to said base portion in accordance with a second degree of freedom;
said first adjuster acting to displace said upper portion with respect to said base portion directly;
said second adjuster acting to displace said upper portion with respect to said base portion solely via a physical interposition between said upper portion and said base portion.

2. The apparatus according to claim 1, wherein said first adjuster comprises an adjustment element which acts on one portion of said upper portion and an adjustment element which acts on a different portion of said upper portion.

3. The apparatus according to claim 1, wherein said adjustment arrangement acts to adjust said upper portion via a computer.
